(19) United States
(12) Patent Application Publication
(10) Pub. No.: US 2025/0118838 A1
(43) Pub. Date: Apr. 10, 2025

(54) BATTERY SEALING

(71) Applicant: Levono (Singapore) Pte. Ltd., Singapore (SG)

(72) Inventors: Bouziane Yebka, Apex, NC (US); Tin-Lup Wong, Chapel Hill, NC (US); Philip J. Jakes, Durham, NC (US)

(21) Appl. No.: 18/483,353

(22) Filed: Oct. 9, 2023

(51) Int. Cl. H01M 50/197; H01M 50/119; H01M 50/121

(52) U.S. Cl. CPC H01M 50/197; H01M 50/119; H01M 50/121

(57) ABSTRACT

Several battery systems include multiple layers of one or more of polymers, metals and fibers.

### TECHNICAL FIELD

Embodiments described herein generally relate to the sealing of batteries.

### BACKGROUND

The seal area of a battery cell is the most important area for battery safety and integrity for controlling moisture and air ingress. Specifically, imperfections in the sealing area can expose the internal components of a battery. However, simply increasing the sealing application time, pressure and temperature will not solve seal area problems.

A typical pouch sealing wall used to seal a battery includes a first layer of a first polymer such as nylon, a second layer of aluminum or other metal, and a third layer of a second polymer such as polypropylene. In a typical structure, there are two pouch walls, and the second polymer layers face each other and are sealed on the edges. With current sealing arrangements and processes, air and moisture can penetrate the battery cell, the moisture reacts with the battery materials, gases are generated, and battery swelling occurs.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1A and 1B are diagrams of an embodiment of a battery sealing system.

FIG. 2 is a diagram of another embodiment of a battery sealing system.

FIGS. 3A, 3B and 3C are a diagram of another embodiment of a battery sealing system.

FIG. 4 is a diagram of another embodiment of a battery sealing system.

FIG. 5 is a diagram of another embodiment of a battery sealing system.

### DETAILED DESCRIPTION

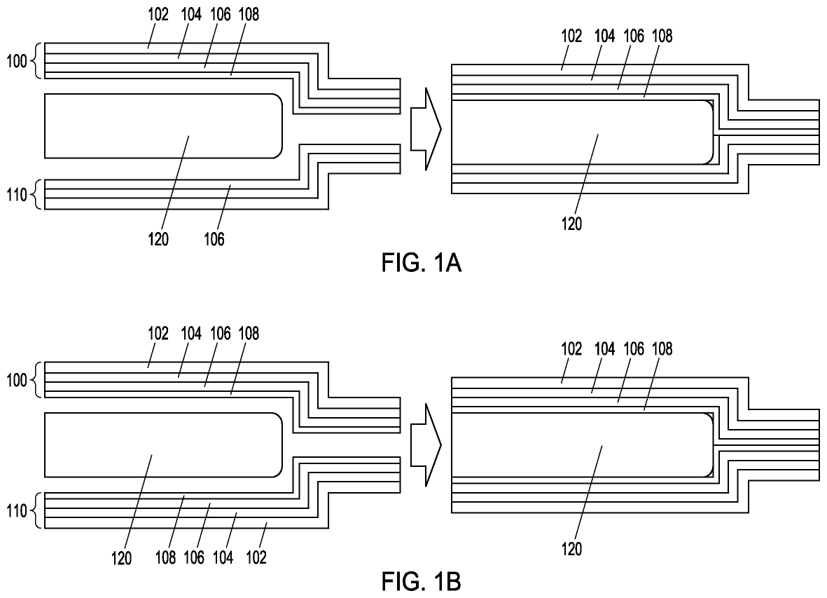

FIGS. 1A and 1B are diagrams of an embodiment of a battery sealing system. FIG. 1A illustrates pouch walls 100 and 110, which when implemented surround and enclose a battery 120. FIG. 1A further illustrates a first layer 102, a second layer 104, a third layer 106 and a fourth layer 108. The first layer 102 consists of a first polymer. The second layer 104 consists of a metal. The third layer 106 consists of a second polymer. The fourth layer 108 consists of a high temperature fiber. As can be seen from FIG. 1A, the second layer is adjacent to the first layer, the third layer is adjacent to the second layer, and the fourth layer is adjacent to the third layer. The multiple layers and the materials of these multiple layers of the embodiments of FIGS. 1A and 1B, like with the other embodiments disclosed herein, increase the mechanical strength of the pouch, which can withstand external damage due to the screws or other sharp objects.

In an embodiment, the first polymer is a first thermoplastic polymer resin and the second polymer is a second thermoplastic polymer resin. The first thermoplastic polymer resin and the second thermoplastic polymer resin have different melting points. The first thermoplastic polymer resin can be terephthalate and the second thermoplastic polymer resin can be polypropylene. The metal layer can be aluminum, copper or stainless steel. The high temperature fiber can be a polyester fiber.

As can be seen in FIG. 1A, the first layer 102 is an outer layer of the pouch wall. The fourth layer 108 is an inner layer of the pouch wall, that is, it is next to the battery 120. The fourth layer 108 is configured for positioning adjacent a battery cell and for sealing to a second pouch with the fourth layer. However, in another embodiment, the second pouch wall may not have a fourth layer 108. In an embodiment, the fourth layer 108 is an integral layer of the pouch wall. In another embodiment, the fourth layer comprises a non-integral layer of the pouch wall, that is, it is added to an existent pouch wall; it is not included in the initial formation of the pouch wall.

As illustrated in FIG. 1A, the fourth layer 108 is on the pouch wall 100, but not on the pouch wall 110. When the two pouch walls are sealed together in FIG. 1A, the fourth layer 108 adheres to the third layer 106 of pouch wall 110. In another embodiment, as illustrated in FIG. 1B, both pouch walls 100 and 110 include a fourth layer 108, which are then sealed to each other.

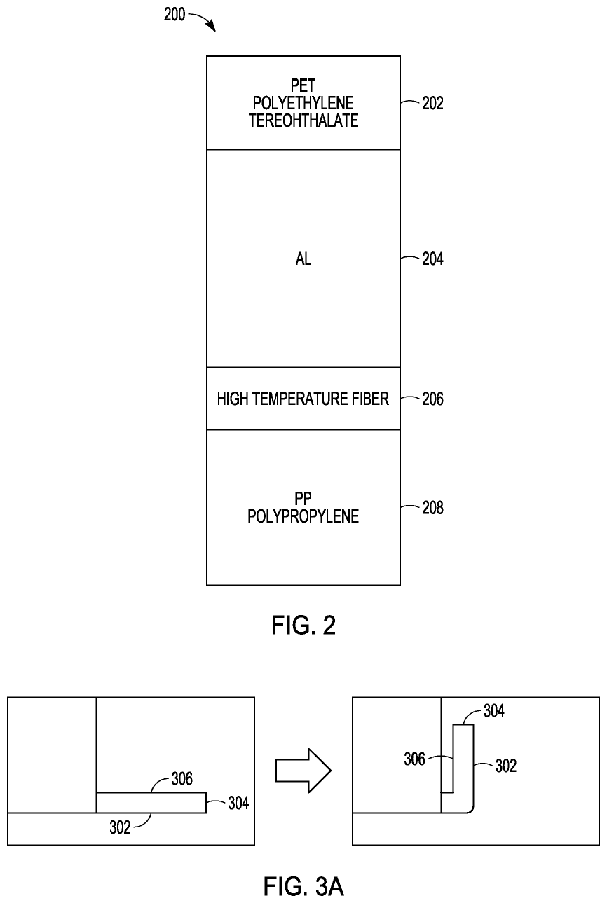

FIG. 2 is a diagram of another embodiment of a battery sealing system 200. In FIG. 2, a pouch wall for sealing a battery includes a first layer 202, a second layer 204, a third layer 206, and a fourth layer 208. The first layer 202 is a first polymer. The second layer 204 is a metal. The third layer 206 is a high temperature fiber. The fourth layer 208 is a second polymer. As can be seen in FIG. 2, the second layer is adjacent to the first layer, the third layer is adjacent to the second layer, and the fourth layer is adjacent to the third layer.

The first polymer is a first thermoplastic polymer resin and the second polymer is a second thermoplastic polymer resin. The first thermoplastic polymer resin and the second thermoplastic polymer resin have different melting points. In an embodiment, the first thermoplastic polymer resin is polyethylene terephthalate and the second thermoplastic polymer resin is polypropylene. The metal layer can be aluminum, copper or stainless steel. The high temperature fiber can be a polyester fiber, such as mylar. The high temperature fiber can have a melting point of greater than 100 degrees centigrade, be an electrical insulator, be chemically stable with organic solvents, have a thickness of less than 15 micrometers, be flexible, include no more than two layers, and have an open grid structure. Additionally, in an embodiment, the first layer is approximately 10 micrometers thick, the second layer is approximately 30 micrometers thick, the third layer is approximately 5 micrometers thick, and the fourth layer is approximately 20 micrometers thick.

The first layer is an outer layer of the pouch. The fourth layer is an inner layer of the pouch, that is, the fourth layer is positioned adjacent a battery cell.

When the pouch wall is used to seal a battery, a second pouch wall having the second polymer layer is placed adjacent to the second polymer layer of the first pouch wall, such that the second polymer layers of each pouch wall form the seal. The second pouch wall, like the first pouch wall, includes a high temperature fiber layer, a metal layer, and a first polymer layer. On the second pouch wall, the high temperature fiber layer is adjacent to the metal layer, and the metal layer is adjacent to the first polymer layer.

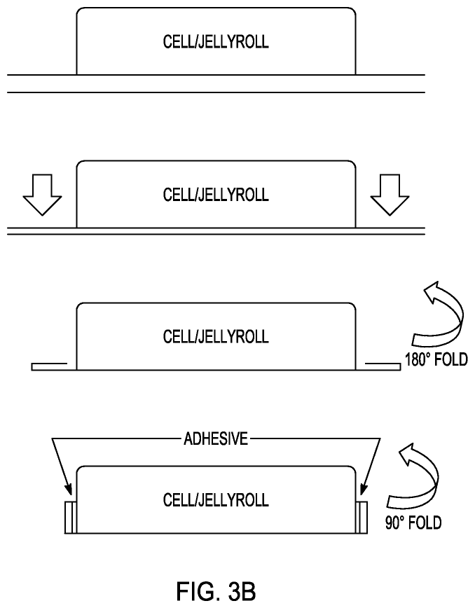

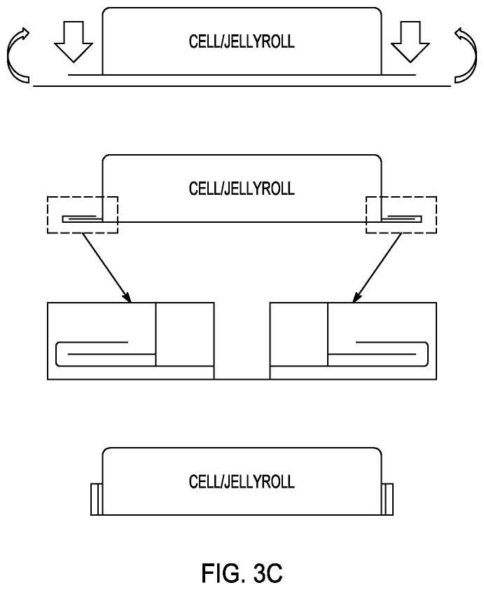

FIGS. 3A, 3B and 3C are diagrams of another embodiment of a battery sealing system. Referring to FIG. 3A, the battery sealing system includes a first layer 302, a second layer 304 and a third layer 306. As further illustrated in FIG. 3A, the second layer 304 is adjacent to the first layer 302 and the third layer 306 is adjacent to the second layer 304. In an embodiment, as illustrated in FIG. 3C, the third layer 306 extends beyond the first layer 302. The first layer is a first polymer and the third layer is a second polymer. The first polymer can be a first thermoplastic polymer resin such as polyethylene terephthalate and the second polymer can be a second thermoplastic polymer resin such as polypropylene. The first thermoplastic polymer resin and the second thermoplastic polymer resin can have differing melting points. The second layer is a metal. The metal can be aluminum, copper or stainless steel. As illustrated in FIGS. 3B and 3C, the first, second and third layers are first folded into an angle of approximately 180 degrees, and then the first, second and third layers are folded into an angle of approximately 90 degrees. In an embodiment, an adhesive is placed next to the 90-degree fold.

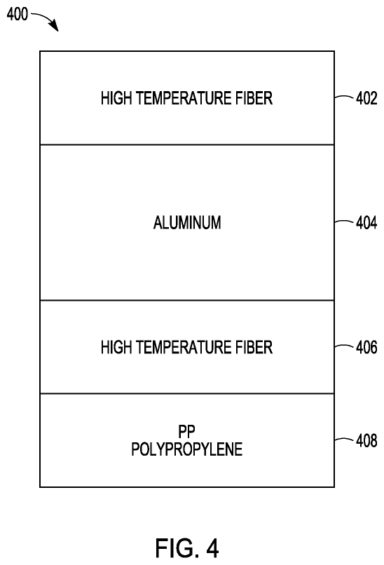

FIG. 4 is a diagram of another embodiment of a battery sealing system 400. FIG. 4 illustrates a battery sealing system 400 that includes a first layer 402, a second layer 404, a third layer 406 and a fourth layer 408. The first layer can be a high temperature fiber, the second layer is a metal, the third layer is another layer of the high temperature fiber, and the fourth layer is a polymer. As illustrated in FIG. 4, the second layer is adjacent to the first layer, the third layer is adjacent to the second layer, and the fourth layer is adjacent to the third layer. The polymer can be a thermoplastic polymer resin such as polyethylene terephthalate or polypropylene. The metal can be aluminum, copper or stainless steel. The high temperature fiber can be a polyester fiber. The first layer is an outer layer of the pouch wall, and the fourth layer is an inner layer of the pouch wall. The fourth layer is configured for positioning adjacent a battery cell and for sealing to a second pouch wall with the fourth layer. In an embodiment, the first layer is approximately 10 microns thick, the second layer is approximately 20 microns thick, the third layer is approximately 10 microns thick, and the fourth layer is approximately 10 microns thick.

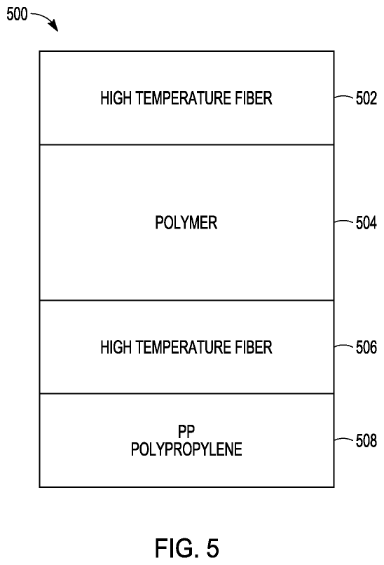

FIG. 5 is a diagram of another embodiment of a battery sealing system 500. The battery sealing system 500 includes a first layer 502, a second layer 504, a third layer 506 and a fourth layer 508. The first layer is a high temperature fiber such as polyester. The second layer is a first polymer. The third layer is another layer of the high temperature fiber. The fourth layer is a second polymer. The second layer is adjacent to the first layer, the third layer is adjacent to the second layer, and the fourth layer is adjacent to the third layer. The first layer comprises an outer layer of the pouch wall, and the fourth layer comprises an inner layer of the pouch wall, the fourth layer is configured for positioning adjacent a battery cell, and for sealing to a second pouch with the fourth layer. In an embodiment, the first layer is approximately 10 microns thick, the second layer is approximately 20 microns thick, the third layer is approximately 10 microns thick, and the fourth layer is approximately 10 microns thick.

### EXAMPLES

Example No. 1 is a pouch wall for sealing a battery comprising a first layer comprising a first polymer; a second layer comprising a metal; a third layer comprising a second polymer; and a fourth layer comprising a high temperature fiber.

Example No. 2 includes all the features of Example No. 1, and optionally includes a pouch wall wherein the second layer is adjacent to the first layer, the third layer is adjacent to the second layer, and the fourth layer is adjacent to the third layer.

Example No. 3 includes all the features of Example Nos. 1-2, and optionally includes a pouch wall wherein the first polymer comprises a first thermoplastic polymer resin and the second polymer comprises a second thermoplastic polymer resin, the first thermoplastic polymer resin and the second thermoplastic polymer resin having different melting points; and wherein the metal comprises aluminum, copper or stainless steel.

Example No. 4 includes all the features of Example Nos. 1-3, and optionally includes a pouch wall wherein the first layer comprises an outer layer of the pouch wall, and the fourth layer comprises an inner layer of the pouch wall, the fourth layer configured for positioning adjacent a battery cell.

Example No. 5 includes all the features of Example Nos. 1-4, and optionally includes a pouch wall wherein the fourth layer comprises an integral layer of the pouch wall.

Example No. 6 includes all the features of Example Nos. 1-5, and optionally includes a pouch wall wherein the fourth layer comprises a non-integral layer of the pouch wall.

Example No. 7 includes all the features of Example Nos. 1-6, and optionally includes a pouch wall wherein the high temperature fiber comprises a polyester fiber.

Example No. 8 is a pouch wall for sealing a battery comprising a first layer comprising a first polymer; a second layer comprising a metal; a third layer comprising a high temperature fiber; and a fourth layer comprising a second polymer.

Example No. 9 includes all the features of Example No. 8, and optionally includes a pouch wall wherein the second layer is adjacent to the first layer, the third layer is adjacent to the second layer, and the fourth layer is adjacent to the third layer.

Example No. 10 includes all the features of Example Nos. 8-9, and optionally includes a pouch wall wherein the high temperature fiber comprises a polyester fiber.

Example No. 11 includes all the features of Example No. 8-10, and optionally includes a pouch wall wherein the first polymer comprises a first thermoplastic polymer resin and the second polymer comprises a second thermoplastic polymer resin, the first thermoplastic polymer resin and the second thermoplastic polymer resin having differing melting points; wherein the metal comprises aluminum, copper or stainless steel; and wherein the high temperature fiber comprises a polyester fiber.

Example No. 12 includes all the features of Example Nos. 8-11, and optionally includes a pouch wall wherein the first layer comprises an outer layer of the pouch, and the fourth layer comprises an inner layer of the pouch, the fourth layer configured for positioning adjacent a battery cell.

Example No. 13 includes all the features of Example Nos. 8-12, and optionally includes a pouch wall comprising a fifth layer comprising the high temperature fiber; a sixth layer comprising the metal; and a seventh layer comprising the first polymer.

Example No. 14 includes all the features of Example Nos. 8-13, and optionally includes a pouch wall wherein the fifth layer is adjacent to the fourth layer, the sixth layer is adjacent to the fifth layer, and the seventh layer is adjacent to the sixth layer.

Example No. 15 is a pouch wall for sealing a battery comprising a first layer comprising a first polymer; a second layer comprising a metal; and a third layer comprising a second polymer; wherein the first layer, the second layer and the third layer comprise an edge; wherein the edge comprises a first fold of approximately 180 degrees; and wherein the edge comprises a second fold of approximately 90 degrees.

Example No. 16 includes all the features of Example No. 15, and optionally includes a pouch wall wherein the second layer is adjacent to the first layer and the third layer is adjacent to the second layer.

Example No. 17 includes all the features of Example Nos. 15-16, and optionally includes a pouch wall comprising an adhesive positioned adjacent to the second fold.

Example No. 18 includes all the features of Example Nos. 15-17, and optionally includes a pouch wall wherein the third layer is longer than the first layer.

Example No. 19 includes all the features of Example Nos. 15-18, and optionally includes a pouch wall wherein the first polymer comprises a first thermoplastic polymer resin and the second polymer comprises a second thermoplastic polymer resin, the first thermoplastic polymer resin and the second thermoplastic polymer resin having differing melting points; and wherein the metal comprises aluminum, copper or stainless steel.

Example No. 20 is a pouch wall for sealing a battery comprising a first layer comprising a high temperature fiber; a second layer comprising a metal; a third layer comprising the high temperature fiber; and a fourth layer comprising a polymer.

Example No. 21 includes all the features of Example No. 20, and optionally includes a pouch wall wherein the second layer is adjacent to the first layer, the third layer is adjacent to the second layer, and the fourth layer is adjacent to the third layer.

Example No. 22 includes all the features of Example Nos. 20-21, and optionally includes a pouch wall wherein the polymer comprises a first thermoplastic polymer resin; wherein the metal comprises aluminum, copper or stainless steel; and wherein the high temperature fiber comprises a polyester fiber.

Example No. 23 includes all the features of Example No. 20-22, and optionally includes a pouch wall wherein the first layer comprises an outer layer of the pouch wall, and the fourth layer comprises an inner layer of the pouch wall, the fourth layer configured for positioning adjacent a battery cell.

Example No. 24 is a pouch wall for sealing a battery comprising a first layer comprising a polyester; a second layer comprising a first polymer; a third layer comprising the polyester; and a fourth layer comprising a second polymer.

Example No. 25 includes all the features of Example No. 24, and optionally includes a pouch wall wherein the second layer is adjacent to the first layer, the third layer is adjacent to the second layer, and the fourth layer is adjacent to the third layer.

Example No. 26 includes all the features of Example Nos. 24-25, and optionally includes a pouch wall wherein the first layer comprises an outer layer of the pouch wall, and the fourth layer comprises an inner layer of the pouch wall, the fourth layer configured for positioning adjacent a battery cell.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A pouch wall for sealing a battery comprising:
a first layer comprising a first polymer;
a second layer comprising a metal;
a third layer comprising a second polymer; and
a fourth layer comprising a high temperature fiber.

2. The pouch wall of claim 1, wherein the second layer is adjacent to the first layer, the third layer is adjacent to the second layer, and the fourth layer is adjacent to the third layer.

3. The pouch wall of claim 1, wherein the first polymer comprises a first thermoplastic polymer resin and the second polymer comprises a second thermoplastic polymer resin, the first thermoplastic polymer resin and the second thermoplastic polymer resin having different melting points; and wherein the metal comprises aluminum, copper or stainless steel.

4. The pouch wall of claim 1, wherein the first layer comprises an outer layer of the pouch wall, and the fourth layer comprises an inner layer of the pouch wall, the fourth layer configured for positioning adjacent a battery cell.

5. The pouch wall of claim 1, wherein the fourth layer comprises an integral layer of the pouch wall.

6. The pouch wall of claim 1, wherein the fourth layer comprises a non-integral layer of the pouch wall.

7. The pouch wall of claim 1, wherein the high temperature fiber comprises a polyester fiber.

8. A pouch wall for sealing a battery comprising:
a first layer comprising a first polymer;
a second layer comprising a metal;
a third layer comprising a high temperature fiber; and
a fourth layer comprising a second polymer.

9. The pouch wall of claim 8, wherein the second layer is adjacent to the first layer, the third layer is adjacent to the second layer, and the fourth layer is adjacent to the third layer.

10. The pouch wall of claim 8, wherein the high temperature fiber comprises a polyester fiber.

11. The pouch wall of claim 8, wherein the first polymer comprises a first thermoplastic polymer resin and the second polymer comprises a second thermoplastic polymer resin, the first thermoplastic polymer resin and the second thermoplastic polymer resin having differing melting points; wherein the metal comprises aluminum, copper or stainless steel; and wherein the high temperature fiber comprises a polyester fiber.

12. The pouch wall of claim 8, wherein the first layer comprises an outer layer of the pouch, and the fourth layer comprises an inner layer of the pouch, the fourth layer configured for positioning adjacent a battery cell.

13. The pouch wall of claim 8, comprising:
a fifth layer comprising the high temperature fiber;
a sixth layer comprising the metal; and
a seventh layer comprising the first polymer.

14. The pouch wall of claim 13, wherein the fifth layer is adjacent to the fourth layer, the sixth layer is adjacent to the fifth layer, and the seventh layer is adjacent to the sixth layer.

15. A pouch wall for sealing a battery comprising:
a first layer comprising a first polymer;
a second layer comprising a metal; and
a third layer comprising a second polymer;
wherein the first layer, the second layer and the third layer comprise an edge;
wherein the edge comprises a first fold of approximately 180 degrees; and
wherein the edge comprises a second fold of approximately 90 degrees.

16. The pouch wall of claim 15, wherein the second layer is adjacent to the first layer and the third layer is adjacent to the second layer.

17. The pouch wall of claim 15, comprising an adhesive positioned adjacent to the second fold.

18. The pouch wall of claim 15, wherein the third layer is longer than the first layer.

19. The pouch wall of claim 15, wherein the first polymer comprises a first thermoplastic polymer resin and the second polymer comprises a second thermoplastic polymer resin, the first thermoplastic polymer resin and the second thermoplastic polymer resin having differing melting points; and wherein the metal comprises aluminum, copper or stainless steel.
